(19) United States
(12) Patent Application Publication
(10) Pub. No.: US 2015/0186764 A1
(43) Pub. Date: Jul. 2, 2015

(54) MACHINE-READABLE CODES

(71) Applicant: CATERPILLAR INC., Peoria, IL (US)

(72) Inventor: Mark Taylor ALLOTT, Mapleton, IL (US)

(73) Assignee: CATERPILLAR INC., Peoria, IL (US)

(21) Appl. No.: 14/146,288

(22) Filed: Jan. 2, 2014

(51) Int. Cl. G06K 19/06; G06K 19/02

(52) U.S. Cl. CPC G06K 19/0615; G06K 19/06037; G06K 19/02

(57) ABSTRACT

Disclosed are various exemplary embodiments of a machine-readable code placed on an article and containing information relating to the article, where the code may be readable by a machine to retrieve the information. A portion of the code may be formed of a material that is reactive to a predetermined condition such that, when the article is subjected to the predetermined condition, the portion of the code may be changed to reflect in the information retrievable by the machine that the article has been subjected to the predetermined condition.

### TECHNICAL FIELD

The present disclosure relates generally to a device and method for monitoring product quality and, more particularly, to a machine-readable code of a product that may change in response to an environmental condition to which the product may be exposed.

### BACKGROUND

Machine-readable codes, such as, for example, barcodes and Quick Reference (“QR”) codes, are widely used to provide a variety of different types of information relating to objects to which they are attached. QR codes, in particular, may store a large volume of data representing, for example, texts, photos, videos, URL links, and geo-coordinates to provide information and resources about the objects or companies associated with the objects. In general, these machine-readable codes include dots, lines, polygons, and other geometric patterns in one, two, or three dimensions with varying sizes, widths, and spacings to store data. The stored data can be interpreted and/or retrieved by a scanning device, such as, for example, an optical scanner, a mobile device, or a smartphone with a suitable reader application.

In one exemplary application, a machine-readable code can be placed on a product or product packaging to monitor quality of the product. For example, Korean Application Publication No. 10-2013-0037077 (“the '077 Publication”) discloses an article quality monitoring system that includes a QR code attached to a first packaging of an article and a RFID tag attached to a second packaging containing the first packaging. The RFID tag stores information relating to the history of the atmospheric conditions at which the article has been exposed and transmits that information to a quality prediction server. The QR code stores a URL link to the quality prediction server, which provides a user with the information transmitted by the RFID tag and a quality indication for the article associated with the QR code.

### SUMMARY

According to one exemplary aspect, the present disclosure is directed to a machine-readable code placed on an article and containing information relating to the article. The code may be readable by a machine to retrieve the information. A portion of the code may be formed of a material that is reactive to a predetermined condition such that, when the article is subjected to the predetermined condition, the portion of the code may be changed to reflect in the information retrievable by the machine that the article has been subjected to the predetermined condition.

Another exemplary aspect of the present disclosure may provide an article comprising an article body and a machine-readable code placed on the article body, where the code contains information relating to the article. The code may be readable by a machine to retrieve the information. A portion of the code may be formed of a material that is reactive to a predetermined condition such that, when the article body is subjected to the predetermined condition, the portion of the code may be changed to reflect in the information retrievable by the machine that the article has been subjected to the predetermined condition.

In still another exemplary aspect, the present disclosure is directed to a filter element. The filter element includes a filter body and a machine-readable code placed on the filter body. The code may contain information relating to the filter element and may be readable by a machine to retrieve the information. A portion of the code may be formed of a material that is reactive to a predetermined condition such that, when the filter element is subjected to the predetermined condition, the portion of the code may be changed to reflect in the information retrievable by the machine that the filter element has been subjected to the predetermined condition.

### BRIEF DESCRIPTION OF THE DRAWINGS

FIG. 1 is a schematic illustration of a QR code with portions that may change in response to exposure to various environmental conditions, according to one exemplary embodiment of the present disclosure; and

FIG. 2 is a partial perspective view of a filter element for filtering fluid with the QR code of FIG. 1 placed on a surface thereof, according to one exemplary embodiment.

### DETAILED DESCRIPTION

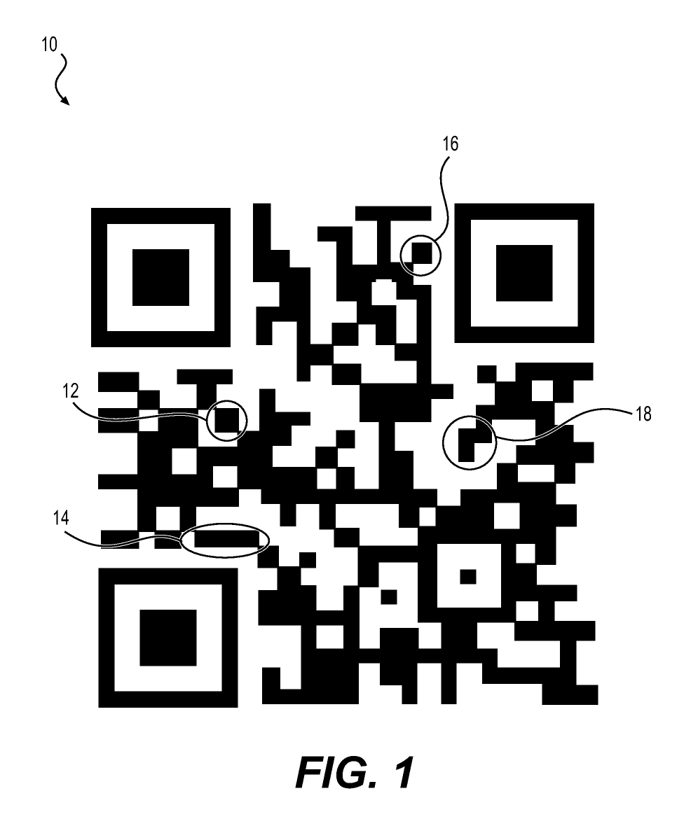

FIG. 1 illustrates a QR code 10 as an exemplary machine-readable code that may change its pattern in response to exposure to certain environmental conditions. While various embodiments of the present disclosure will be described in connection with a particular fluid filter (e.g., filter elements for combustion engines), it should be understood that the present disclosure may be applied to, or used in connection with, virtually all types of products in the marketplace, ranging from food products and other consumables to electronic devices and components.

Referring to FIG. 1, QR code 10 is one of many different types of machine-readable codes that may be used consistent with one or more exemplary aspects of the present disclosure. QR code 10 may contain various kinds of information in virtually any type of data format. For example, QR code 10 may contain information relating to a product or a company associated with it (e.g., photos, videos, and URL links) in numeric, alphanumeric, and/or binary data format. Such information is represented by a two-dimensional array of black dots arranged in a square grid, which forms a pattern that can be read by a suitable scanning device, such as, for example, a smartphone equipped with a camera and a QR reader application. The scanning device can extract the information represented by the pattern and provide the extracted information to a user.

According to one exemplary aspect of the present disclosure, QR code 10 may be configured to detect and/or indicate a particular change in the environment. For example, at least a portion 12, 14, 16, 18 of QR code 10 may be formed of a material that is reactive to a particular environmental condition to which QR code 10 may be exposed. The term “material” that is reactive to a particular environmental condition, as used herein, may refer to any type of material that is used to form a portion of a machine-readable code in one-, two-, or three-dimensional geometry and that reacts to the predetermined condition to change a pattern of the machine-readable code. An example of the “material” may include, but be not limited to, reactive ink and reactive polymer. Additionally, the “material” may include, but not be limited to, heat reactive waxes, plastic polymers, solid chemical reagents, and solid chemical reactants. Thus, when QR code 10 is exposed to the particular environmental condition, portion 12, 14, 16, or 18 of QR code 10 may change its shape, size, and/or color to indicate that QR code 10 or a product to which QR code 10 is affixed is exposed or otherwise subjected to the particular environmental condition. As shown in FIG. 1, different portions 12, 14, 16, and 18 may be formed of different materials, each being independently reactive to a different environmental condition.

According to various exemplary embodiments, the environmental conditions for monitoring and/or detection may include, but not be limited to, excessive heat above a predetermined temperature, presence of a particular contaminant, exposure to UV-rays, and passage of a predetermined time period.

For example, a first portion 12 of QR code 10 may be printed with thermo-sensitive ink that is reactive to heat above a threshold temperature. Accordingly, when QR code 10 is exposed to heat above the threshold temperature, the ink in first portion 12 may appear in or disappear from QR code 10, thus changing the pattern of QR code 10. Alternatively or additionally, the reactive ink may change its shape, size, or color from the initial pattern. The changed pattern of QR code 10 may add to or otherwise indicate in the information contained in QR code 10 that QR code 10 and/or a product to which QR code 10 is affixed has been subjected to the heat above the threshold temperature.

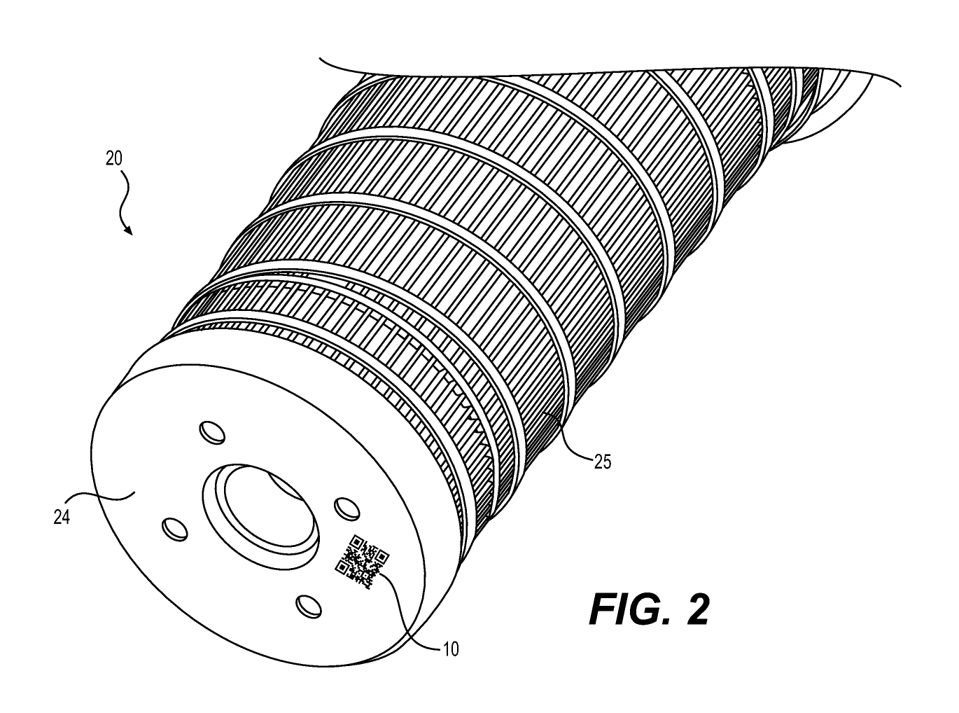

Additionally or alternatively, QR code 10 may include a second portion 14 printed with ink that is reactive to a particular chemical agent, contaminant, or undesirable additive. In one exemplary embodiment, as shown in FIG. 2, QR code 10 may be placed on a filter element 20 for filtering lubrication oil of a combustion engine, and the chemical contaminant to be monitored and/or detected may include glycol (e.g., propylene or ethylene glycol), which is the main ingredient for coolant of a combustion engine and can find its way into the lubricating oil in a variety of ways. The presence of glycol in the lubricating oil may expose the engine to a number of potential failures, including deteriorated seals, cracked cylinder heads, corrosion cylinder liners, etc. in a short period of time.

To monitor or detect the presence of glycol, QR code 10 may be placed on a surface of a filter body 25 at a location where QR code 10 can be in contact with the lubricating oil flowing through filter element 20. For example, QR code 10 may be placed on an end cap 24, as shown in FIG. 2. QR code 10 may be printed on a label that is affixed to end cap 24 or may be directly printed on a surface of end cap 24. Accordingly, when the lubricating oil flowing through filter element 20 is contaminated with glycol above a predetermined concentration, the ink in second portion 14 may react with glycol in the lubricating oil and appear in or disappear from QR code 10, thus changing the pattern of QR code 10. Alternatively or additionally, the ink in portion 14 may change its shape, size, and/or color. The changed pattern of QR code 10 may add to or otherwise indicate in the information contained in QR code 10 that filter element 20 has been contaminated with glycol.

According to another exemplary embodiment, QR code 10 may include third and fourth portions 16, 18 printed with inks that react to other environmental conditions, such as exposure to UV-rays or passage of a predetermined time period. For example, third portion 16 may be printed with photochromic ink that appear, disappear, or change color in response to an exposure to UV-rays, and fourth portion 18 may be printed with time-sensitive ink that appear, disappear, or change color in response to passage of a predetermined period of time.

In various exemplary embodiments, the above-described changes in portions 12, 14, 16, and 18 of QR code 10 may be irreversible. In other words, the changes made to QR code 10 in response to the corresponding environmental conditions may be permanent such that, once the product has been exposed to the particular environmental condition, the exposure information is permanently stored in QR code 10. Alternatively, the changes made to QR code 10 in response to a particular environmental condition may be reversible.

It should be understood that, while the exemplary embodiment shown in FIG. 1 includes four portions 12, 14, 16, 18 that may react to four different environmental conditions, the present disclosure is not limited to this particular arrangement. For example, various exemplary embodiments of QR code 10, consistent with the present disclosure, may include less than or more than four portions, depending on the environmental conditions the associated product is intended to monitor or detect. Moreover, QR code 10 may include two or more portions that may react to the same environmental condition as a fail-proof mechanism.

As mentioned above, QR code 10, used to describe various aspects of the present disclosure, is exemplary only. Any other suitable machine-readable codes or tags (e.g., Microsoft Tag), known in the art can be used alternatively.

### INDUSTRIAL APPLICABILITY

The disclosed machine-readable codes may be applicable to various filter elements, such as, for example, oil filters, fuel filters, and air filters of various internal combustion engines. When installed, a machine-readable code placed on a filter element may provide a quick and easy way of determining whether the filter element has been exposed or subjected to one or more prescribed environmental conditions. As will be described in more detail herein, this may reduce the maintenance costs by eliminating or substantially reducing the need for expensive, time-consuming maintenance procedures to detect potential damages to the engine and its components.

For example, in one exemplary embodiment shown in FIG. 2, a machine-readable code 10, represented by a QR code 10 for illustration purposes only, may be applied to a filter element 20 used for filtering lubrication oil of a combustion engine. In this disclosed embodiment, QR code 10 is placed on a surface of a filter body 25 at a location where QR code 10 can be in contact with lubricating oil flowing through filter element 20. For example, QR code 10 may be placed on an end cap 24, as shown in FIG. 2, or at any suitable location of filter body 25. QR code 10 may be printed on a label that is affixed to end cap 24 or may be directly printed on a surface of end cap 24. In an alternative embodiment, QR code 10 may not need to be placed at a location in contact with lubricating oil. For example, depending on the type of environmental condition for monitoring and/or detection, QR code 10 may be placed on, for example, a filter casing (not shown) that houses filter element 20.

According to one exemplary aspect, QR code 10 placed on filter element 20 may include a first portion 12 printed with thermo-sensitive ink that is reactive to temperature above a threshold temperature (e.g., above 300° C.). In general, lubrication oil may oxidize faster at high temperature and generate many undesirable compounds that may result in premature failure of filter element 20. Therefore, it may be beneficial to monitor and/or detect the temperature of the lubrication oil to determine whether the lubrication oil for which filter element 20 is used has been exposed to excessive temperature above the threshold temperature. Accordingly, during operation, QR code 10 placed on end cap 24 may be in contact with the lubrication oil and, when the temperature of the lubrication oil exceeds the threshold temperature, the ink in first portion 12 may change the pattern of QR code 10. The changed pattern of QR code may add to or indicate in the information retrievable by a scanning device that filter element 20 has been subjected to heat or temperature above the threshold temperature.

According to another exemplary aspect, QR code 10 may include a second portion 14 printed with solvent or chemical reactive ink that reacts to a particular chemical contaminant, such as glycol (e.g., propylene or ethylene glycol), which is the main ingredient for coolant of a combustion engine and can find its way into the lubricating oil in a variety of ways. The presence of glycol in the lubricating oil may expose the engine to a number of potential failures, including deteriorated seals, cracked cylinder heads, corrosion cylinder liners, etc. in a relatively short period of time. Thus, it may be beneficial to monitor and/or detect the presence of glycol in the lubricating oil to determine, for example, whether the failure of filter element 20 was a result of the presence of glycol. Accordingly, during operation, when the lubricating oil flowing through filter element 20 is contaminated with glycol above a predetermined concentration, second portion 14 may change the pattern of QR code 10. The changed pattern of QR code 10 may add to or indicate in the information retrievable by a scanning device that filter element 20 has been exposed to lubricating oil contaminated with glycol.

QR code 10 may include any additional or alternative portions 16, 18 that may react to other suitable environmental conditions, such as undesirable liquid additives or contaminant that may indicate potential damages to filter element 20 or engine components.

Any of portions 12, 14, 16, and 18 of QR code 10 may change the pattern of QR code 10 in a number of different ways. For example, portion 12 may initially be substantially transparent until it is exposed to the predetermined environmental condition. That is, first portion 12 may appear in the pattern of QR code 10 only when QR code 10 is exposed to the predetermined environmental condition. Alternatively, first portion 12, which appears in the initial pattern of QR code 10, may disappear when QR code 10 is exposed to the predetermined environmental condition. Additionally or alternatively, first portion 12 may change its shape, size, and/or color, rather than appearing or disappearing, to reflect the predetermined environmental condition.

According to various exemplary aspects, the information retrievable by the changed pattern of QR code 10 may be useful in a number of applications. For example, a product warranty provider can use that information to determine whether filter element 20 has been misused or abused because detecting such misuse or abuse can be extremely difficult without examining the entire device or carrying out full scheduled oil sampling analyses. The ability to quickly determine whether filter element 20 has been exposed to certain environmental condition by simply scanning QR code 10 may enable the product warranty provider to quickly determine whether or not the warranty covers the filter defect claimed by a customer.

According to another exemplary aspect, machine-readable codes consistent with the present disclosure may be used as a preventive maintenance measure to detect early signs of engine damage. For example, one or more portions of the machine-readable code may be formed of materials that are reactive to one or more particular contaminants and/or metal particles, the presence of which may be early warning signs of engine damage. This may enable quickly detecting the potential for damages before damages become significant.

It will be apparent to those skilled in the art that various modifications and variations can be made to the disclosed machine-readable codes and/or filter elements. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A machine-readable code placed on an article in a location where the machine-readable code is configured to contact a flowing fluid and containing information relating to the article, the code being readable by a machine to retrieve the information, a portion of the code being formed of a material that is reactive to a predetermined condition of the fluid such that, when the article is subjected to the fluid having the predetermined condition, the portion of the code is changed to reflect in the information retrievable by the machine that the article has been subjected to the fluid having the predetermined condition.

2. The machine-readable code of claim 1, wherein the material that is reactive to the predetermined condition is an ink used to print the portion of the code.

3. The machine-readable code of claim 2, wherein the ink used to print the portion of the code is substantially erasable when the article is subjected to the predetermined condition.

4. The machine-readable code of claim 1, wherein the predetermined condition is a temperature above a predetermined temperature level.

5. The machine-readable code of claim 1, wherein the predetermined condition is an exposure to a predetermined contaminant.

6. The machine-readable code of claim 1, wherein the code is a quick reference code.

7. The machine-readable code of claim 1, wherein the change in the portion of the code is substantially irreversible.

8. An article comprising:
an article body; and
a machine-readable code placed on the article body in a location along a flow path of a fluid flowing through the article and containing information relating to the article, the code being readable by a machine to retrieve the information,
wherein a portion of the code is formed of a material that is reactive to a predetermined condition such that, when the machine-readable code placed on the article body is subjected to the predetermined condition, the portion of the code is changed to reflect in the information retrievable by the machine that the machine-readable code placed on the article body has been subjected to the predetermined condition.

9. The article of claim 8, wherein the code is printed on a label that is affixed to the portion of the article body.

10. The article of claim 8, wherein the material that is reactive to the predetermined condition is an ink used to print the portion of the code.

11. The article of claim 10, wherein the ink used to print the portion of the code is substantially erasable when the article body is subjected to the predetermined condition.

12. The article of claim 8, wherein the predetermined condition is a temperature above a predetermined temperature level.

13. The article of claim 8, wherein the predetermined condition is an exposure to a predetermined contaminant.

14. The article of claim 8, wherein the code is a quick reference code.

15. The article of claim 8, wherein the change in the portion of the code is substantially irreversible.

16. A filter element comprising:
a filter body; and
a machine-readable code placed on the filter body in a location along a flow path of oil flowing through the filter element and containing information relating to the filter element, the code being readable by a machine to retrieve the information,
wherein a portion of the code is formed of a material that is reactive to a glycol concentration above a predetermined concentration such that, when the filter element is subjected to oil having a glycol concentration above the predetermined concentration, the portion of the code is changed to reflect in the information retrievable by the machine that the filter element has been subjected to oil having a glycol concentration above the predetermined glycol concentration.

17. The filter element of claim 16, wherein the material that is reactive to the predetermined condition is an ink used to print the portion of the code.

18. The filter element of claim 17, wherein the ink used to print the portion of the code is substantially erasable when the filter body is subjected to the predetermined condition.

19. (canceled)

20. (canceled)

21. The machine-readable code of claim 1, wherein the fluid comprises lubricating oil, and the predetermined condition is the presence of glycol in the lubricating oil above a predetermined concentration.

22. The filter element of claim 16, wherein a second portion of the code is formed of a material that is reactive to temperatures above a threshold temperature, wherein above the threshold temperature, the oil is configured to oxidize at a predetermined undesirable rate.
